(19) United States
(12) Patent Application Publication
(10) Pub. No.: US 2012/0030438 A1
(43) Pub. Date: Feb. 2, 2012

(54) Method and Apparatus for Performing Skew Removal in the Receiver of a Multi-Lane Communication Link

(75) Inventors: Farhad Shafai, Kanata (CA); Kelvin Spencer, Kanata (CA)

(73) Assignee: SARANCE TECHNOLOGIES INC., Ottawa (CA)

(21) Appl. No.: 12/845,847

(22) Filed: Jul. 29, 2010

(51) Int. Cl. G06F 12/00

(52) U.S. Cl. 711/159; 711/154; 711/E12.001

(57) ABSTRACT

Serial data streams received on multiple data lanes, wherein each data stream is in the form of a series of blocks including a data block preceded by a synchronization block, are deskewed by setting a detection flag in response to the valid detection of one or more synchronization blocks in each data stream, writing received data following the setting of said detection flag for that data stream to memory, and reading data sequentially from each memory under the control of a common output clock in response to the setting of the flag in respect at least a group of the data streams.

### FIELD OF THE INVENTION

This invention relates to communication systems in general and parallel high-speed electrical links in particular. Specifically, the invention describes a treatment at the receiver of parallel high-speed links (or lanes) to ensure that received data on each of the lanes is aligned in time (de-skewed) prior to subsequent processing or transmission.

### BACKGROUND OF THE INVENTION

As digital communication links become increasingly faster, many technical difficulties arise. One of the factors limiting the speed of a communication channel is the property of the physical electrical link, which is usually constrained by the latest electrical and integrated circuit technology to be significantly less than the desired aggregate communication speed. Therefore, it is common practice to employ a number of parallel physical communication lanes to achieve a greater aggregate logical link speed. This is known as Multi Lane Distribution (MLD). A problem then arises as to how the number of physical communication lanes may be re-combined when the individual high-speed lanes have been impaired by various means during their propagation from a transmitter to a receiver. The arrival time difference of the various individual lanes needs to be corrected so that the individual bits may be correctly re-assembled into a prescribed order corresponding to the aggregate link prior to transmission. For example, the bits arriving on individual lanes may have skewed arrival times due to different lengths of wire or PCB trace.

Another possible impairment is jitter and wander of the clock frequencies on the individual lanes. With older transmission technology, these effects could be corrected merely by adjusting the phase of the clock on the receiving circuit such that the received bits are aligned in time with respect to each other. However, with modern high-speed transmission technology, these impairments can accumulate such that the total arrival time difference can amount to many bits. For example, when the speed of a lane is 6.375 Gigabits per second, a path length difference of 10 centimeters on two typical microstrip printed circuit board traces is equivalent to approximately 4.5 bits. Therefore adjusting the phase of receiving clock cannot accommodate the accumulated delay difference. Considering all possible causes of differences in arrival time of the bits on each communication lane, the requirement for de-skew of such arrival times as set out in various specifications can be 100 bits or more [for example Interlaken (Interlaken Protocol Definition; Revision: 11; Jul. 25, 2006; A Joint Specification of Cortina Systems and Cisco Systems) or IEEE 802.3 (see, IEE P802.3ba™ D3.0; Amendment: Media Access Control Parameters, Physical Layers and Management Parameters for 40 Gb/s and 100 Gb/s Operation; November 2009)]. Therefore a flexible means of de-skew is required, which can meet the present day requirements but can also be scaled according to future requirements as the speed of communication links will increase and the total skew will amount to increasing numbers of bits.

Various methods are known to be available for removing the skew resulting from the impairments described above.

For example in one implementation [Pub. US 2008/0279224], the skew among the received channels is measured and a correction is applied at the transmitter to compensate for the skew such that no compensation is required at the receiver. However, this method will only work if the required compensation circuit is actually available at the transmitter, which cannot be guaranteed. Furthermore, the arrival times at the receiver can vary in a dynamic fashion due to jitter and wander on the receiver clock, such that conditions may exist where there is insufficient time to make the proper measurement and feed back the compensation information to the transmitter.

Pub. US 2003/0219040 discloses an apparatus and method for deskew but it requires too many storage locations.

Pub. US 2003/0214975 discloses an alignment and deskew device, system and method.

U.S. Pat. No. 4,115,759 discloses a Multiple Bit Deskew Buffer used for aligning data read from multiple tape tracks.

U.S. Pat. NO. 5,313,501 discloses a Method and Apparatus for Deskewing Digital Data which employs delay lines in each received stream of parallel data.

U.S. Pat. No. 5,408,473 discloses a Method and Apparatus for Transmission of Communication Signals over Two Parallel Channels, which includes a method of removing the channel skew.

The above methods are generally restricted in their application to additional present and future communication protocols.

U.S. Pat. No. 6,654,824 discloses a High-Speed Dynamic Multi-Lane Deskewer, but this requires considerable buffer space for a given range of required skew correction.

U.S. Pat. No. 7,007,115 discloses an invention for Removing Lane-to-Lane Skew. However, it requires a software algorithm to search for symbols stored in memory.

Altera Corporation has published a circuit for performing deskew which employs several stages of FIFO circuits as Application Note AN 573.

### SUMMARY OF THE INVENTION

According to the present invention there is provided an apparatus for deskewing serial data streams received on multiple data lanes, wherein each data stream is in the form of a series of blocks comprising a data block preceded by a synchronization block, the apparatus comprising an alignment detector for each data stream configured to set a detection flag in response to the valid detection of one or more synchronization blocks in each data stream; a memory for each data stream for sequentially storing received data following the setting of said detection flag for that data stream; a read-enable element for setting a read-enable flag in response to the setting of the flag of in respect at least a group of said data streams; and an output element responsive to said read-enable signal to read data sequentially from each memory under the control of a common output clock.

The present invention is an improvement over known methods in at least the following respects. First, it employs fewer logic units in an integrated circuit, thereby saving cost and reducing power consumption. Second, because the present invention employs fewer processing stages, the latency (delay) of data through a system is reduced, thereby improving overall system performance. Third, the method of the present invention is not restricted to particular data rates, number of lanes, or number of skewed bits. Therefore it can be easily scaled to future requirements as technology advances occur. Fourth, the present invention is able to function with different clock domains at the input and output of the receiver, thereby providing an additional feature at no extra expense. Fifth, the present invention can be easily implemented by hardware, firmware, or software.

In one embodiment the invention comprises an apparatus consisting of: inputs from two or more individual bit streams (lanes); a write circuit for temporarily storing the individual bit streams in a corresponding FIFO memory; a read circuit for retrieving the individual bit streams from their storage locations; an algorithm for retrieving the individual bit streams, according to a rule which ensures that the bit streams are retrieved at the proper time; a means of detecting the arrival time differences among the bit streams; an output which passes the properly timed and re-combined bit stream to another apparatus for subsequent processing or transmission. The skew removal method includes the following steps: detect a synchronization or alignment pattern at an alignment circuit corresponding to each lane; set a flag when said pattern is detected; begin writing received data into a FIFO memory starting with said pattern; when all said patterns from all lanes have been detected begin the process of reading from all FIFO memory locations according to a predefined order and continue reading as long as data is being received correctly.

According to another aspect of the invention there is provided a method of deskewing serial data streams received on multiple data lanes, wherein each data stream is in the form of a series of blocks comprising a data block preceded by a synchronization block, the method comprising setting a detection flag in response to the valid detection of one or more synchronization blocks in each data stream; writing received data following the setting of said detection flag for that data stream to memory; and reading data sequentially from each memory under the control of a common output clock in response to the setting of the flag in respect at least a group of said data streams.

### BRIEF DESCRIPTION OF THE DRAWINGS

The invention will now be described in more detail, by way of example only, with reference to the accompanying drawings, in which:

FIG. 1 is a high level illustration of the invention showing the communication links and the processing circuits at the receiver and transmitter. The figure shows a longer transmission path for lane 1, resulting in a delayed arrival time (skew) of the data on lane 1.

FIG. 2 is a detailed illustration of the alignment logic.

FIG. 3 is a detailed illustration of the alignment detector circuit.

FIG. 4 is a flowchart showing the actions occurring in the alignment detector circuit.

FIG. 5 is a flowchart showing the high level functions carried out by the deskew logic.

FIG. 6 is an illustration of the bit streams before skew, with skew, and after skew correction.

### DETAILED DESCRIPTION OF EMBODIMENTS OF THE INVENTION

A detailed description of a preferred embodiment of the invention follows. While the exemplary embodiment illustrates four communication lanes, it is to be understood that the invention may easily be applied to various other combinations for the number of communication lanes and the number of corresponding parallel bit streams.

In the description which follows, the terms “synchronization word”, “synchronization block”, “synchronization pattern”, “alignment word”, “alignment pattern”, “time stamp”, and similar phrasing are all refer to a special data block as the preamble to a string of data blocks that is detectable by an alignment detector in the receiver.

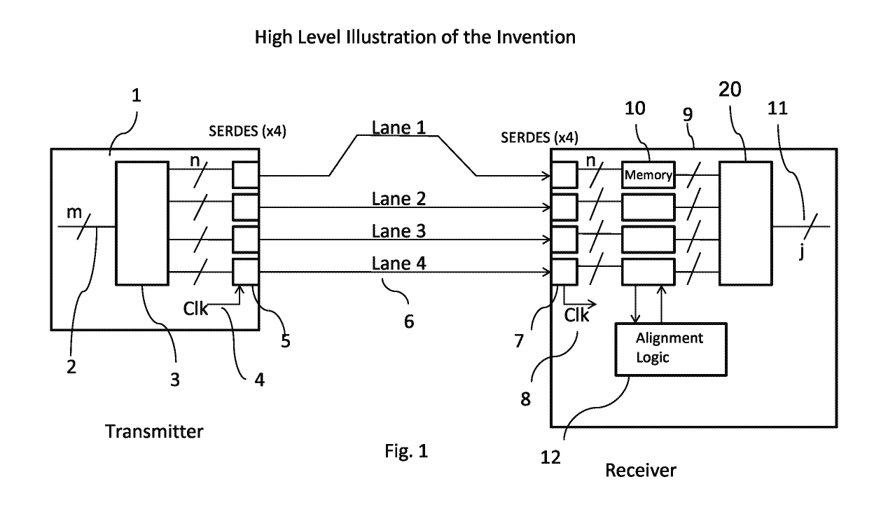

FIG. 1 illustrates a multi-lane communication link at a high level. The illustration shows data transmission in only one direction. However, in many communication systems data flows in both directions (that is, full duplex). For clarity only one direction is described in detail but it is understood that for many such systems a similar transmission path exists in the other direction consisting of additional circuits.

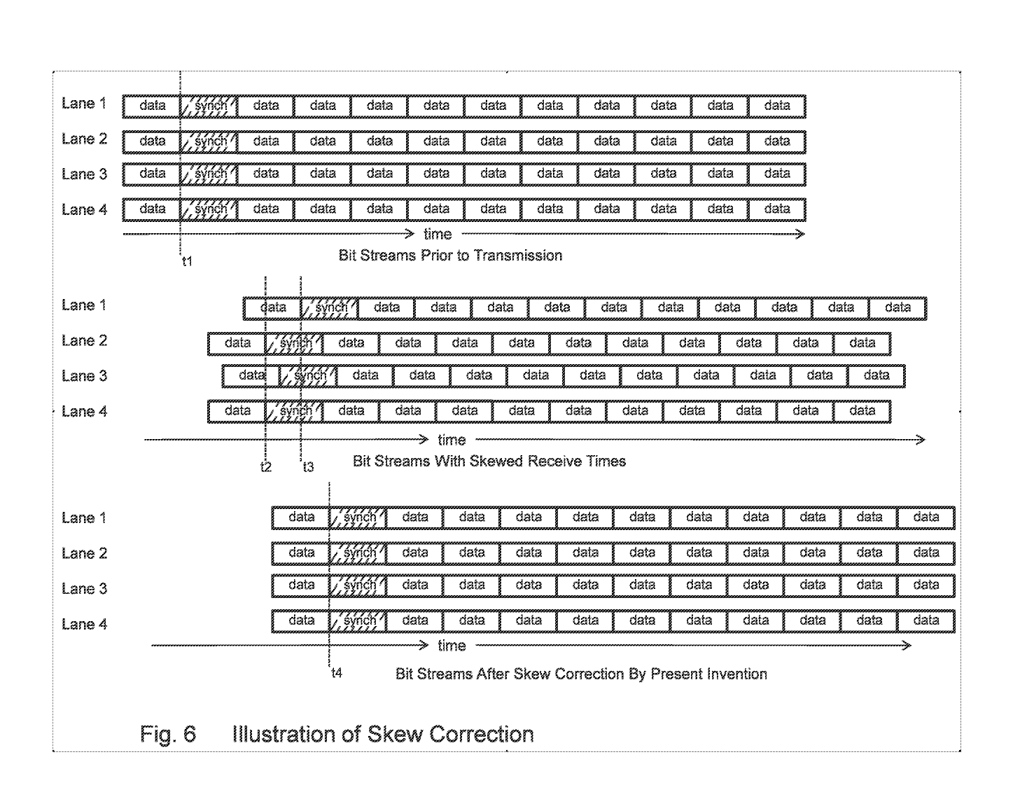

FIG. 6 illustrates four bit streams on four lanes as a function of time transmitted according to a known Multi Lane Distribution (MLD) protocol. Initially each lane is aligned in time such that individual data blocks can be precisely located with respect to time t1. In order to provide a reference for time t1, a special data block “synch” is transmitted periodically according to an interval, which is defined by the particular protocol transmitted on the lanes and the remaining data blocks “data” containing other information are transmitted subsequently. After being sent over a transmission medium and received, the data blocks beginning with a “synch” block for each lane arrive at various times ranging from t2 to t3, where the difference between t2 and t3 is known as skew. After processing by the present invention, the data blocks are re-aligned in time such that the special Synchronization data block corresponding to each lane starts at time t4.

In one embodiment, known as Interlaken, each data block is called a “word” and consists of 8 bytes (64 bits) preceded by an additional 3 bits, an encoding system known as 64 B/67 B, whose function is as follows: to indicate whether the data bits are inverted; to indicate whether the data block is user data or control data; and to indicate word boundaries. Interlaken specifies a special control word called Synch Word whose function is to provide the time reference t1, where the Synch Word is transmitted every 2048 words.

In another embodiment, known as 802.3ba 40/100 Gigabit Ethernet, each data block consists of 8 bytes (64 bits) preceded by a further 2 bits, an encoding system known as 64 B/66 B, whose function is to indicate whether the data block is user data or control data. 802.3ba Gigabit Ethernet specifies a special control data block called an Alignment Word, similar to a Synch Word, whose function is to provide the time reference t1 and an identification indicator corresponding to the particular lane or virtual lane, where the Alignment Word is transmitted approximately every 16,384 words.

In some embodiments the Alignment Word is transmitted at intervals less than or more than every 16,384 words. In other embodiments the clock is recovered at the receiver from the data bit transitions using known Phase Locked Loop (PLL) technology and in other embodiments the clock is transmitted and received as a separate signal. The Synch Words or Alignment Words may be transmitted at different rates depending on the desired performance.

Referring now to FIG. 1, transmitter 1 is presented with a communications link 2 consisting of m individual lines, which represent parallel data. Multiplexing circuit 3 performs functions such as scrambling, word delineation, and CRC calculation and then distributes the bits from at the individual lines m into groups of n lines and forwards those to four Serialize/Deserialize (SerDes) circuits 5. Data bits on each of the m lines are presented in a defined sequence to the SerDes circuits 5 according to the rules of a particular protocol such as Interlaken or 802.3ba Gigabit Ethernet.

The data bits on the n lines are then presented to the corresponding SerDes ouput in order. In a typical application, n=67, m=256, and the number of lanes=4, with each of these numbers being limited only by the capabilities of the semiconductor logic technology which is used to implement the invention, and with m and n being parallel bit paths corresponding to the serial bit stream of each lane. In some embodiments, if m=1 and n=1 then these bit paths are considered to be serial. A common clock 4 is presented to all SerDes circuits to act as a reference frequency for the transmission of serialized data to each of the high-speed lanes 6.

Each of the lanes is comprised of an electrical conductor such as a PCB trace or wire, or a pair of conductors as in the case of differential logic signals, an in the alternative an optical fiber providing an optical link. It is noted that even though each SerDes employs the same reference frequency, in the process of converting the data to a serial stream the relative time difference between each serial stream can vary by as much as n bits due to the potential wander of the transmitting clock, which is derived from the reference clock. Furthermore, the illustration schematically shows Lane 1 as being longer than Lanes 2-4, and therefore the data arriving at its receiver will be delayed due to the finite speed of propagation of the electrical signal in each of the lanes.

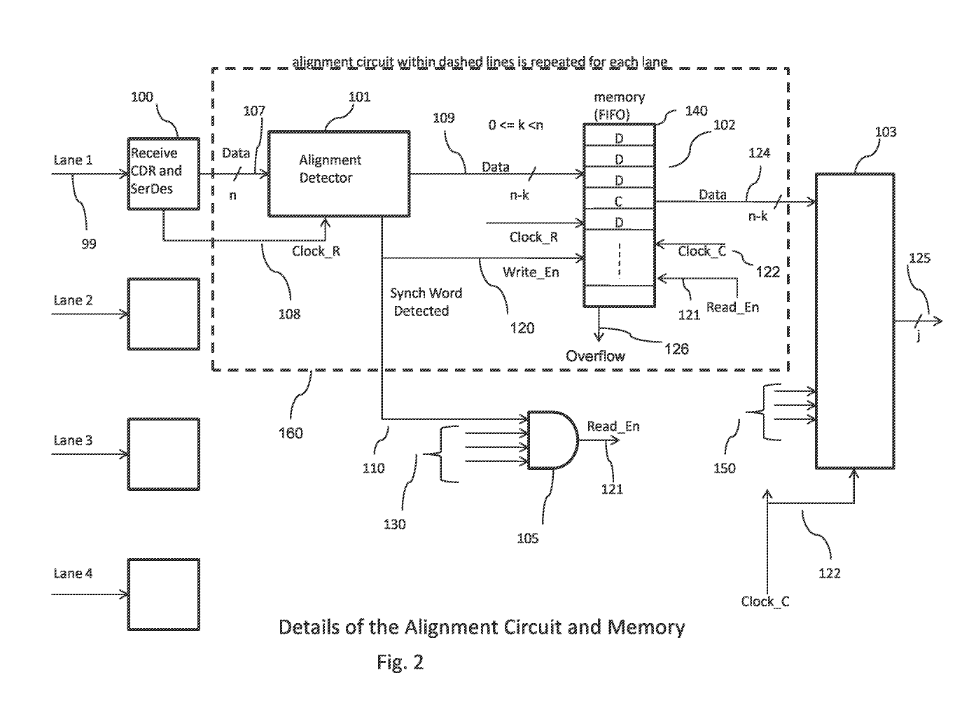

After traversing its electrical path, each lane terminates at its own particular receive SerDes 7 which are parts of receiver 9. Each receive SerDes has as an output of n parallel lines as well as the clock 8 recovered from each lane. Received data bits from each SerDes are loaded sequentially into a First In First Out (FIFO) memory array 10, one array per SerDes, at a time determined by part of the alignment logic 12. After further processing by the alignment logic 12, the aggregate data stream 11 consisting of at least 1 physical link is transferred to further logic or transmission circuits 20 at a time determined by the alignment logic 12. The alignment logic 12 will now be described in more detail with reference to FIG. 2 and

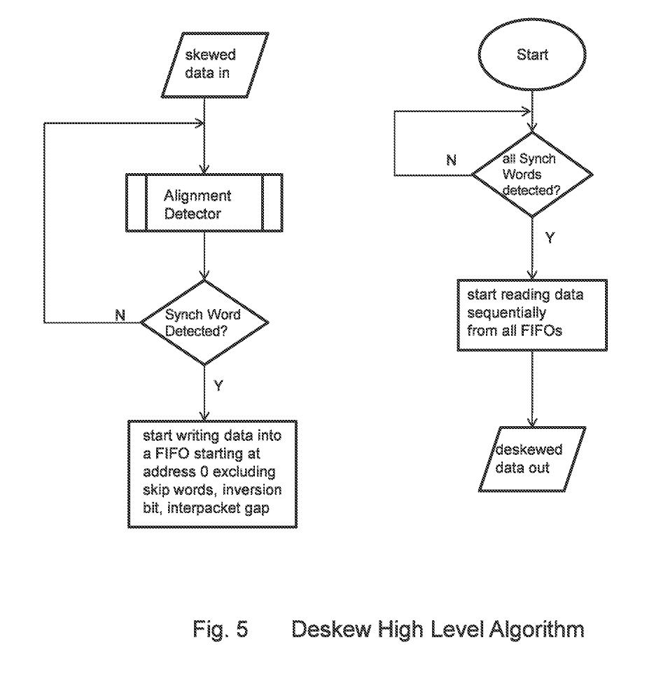

FIG. 5.

Referring to FIG. 2, each of four lanes 99 terminate in their own receiving SerDes 100, each of which includes a known circuit to recover a Clock_R 108 and Data 107 as well as a known demuxing circuit, which converts each serial lane to n parallel lines. While the example illustrates four lanes, it is to be understood that the present invention is not limited by the number of lanes. The alignment detector 101 and memory 140 which will now be described is repeated for each lane, although it will be understood that they could be implemented in software as part of a common system.

Data 107 is transferred to an Alignment Detector circuit 101 which performs at least one of the following functions: determine word boundary; invert bits as required; descramble; CRC32; identify a bit pattern employed for synchronization and produce an indication of the presence of that bit pattern. In some embodiments, functions such as descramble and CRC32 are not required in the alignment detector, for example in the case of 802.3ba Ethernet. In some embodiments, identification of the bit synchronization bit pattern requires that the pattern be detected more than once, for example four times in the instance of the Interlaken protocol. Signal 110, “Synch Word Detected”, is assigned a value TRUE when the synchronization pattern has been reliably detected. The reliable detection of a synchronization word in some embodiments is required to occur at least once, for example four times in the case of the Interlaken protocol. In the event that the synchronization pattern is not detected reliably, the Synch Word Detected signal 110 is assigned a value FALSE. In some embodiments the unreliable detection of the synchronization pattern occurs after more than one error of detection, for example four times in the instance of the Interlaken protocol.

The condition of signal 110 having a TRUE value will cause Clock_R to write the Data 109 into the FIFO memory 102 as a result of the Write_En signal 120 being asserted. In some embodiments, the Synch Word may be known by various other names such as Alignment pattern or unnamed but performing the same function, namely to provide a means of correcting for the skewed arrival time of data on the various lanes.

Data is written into FIFO 102 in order beginning with the first valid data word after the Synch Word at the first memory location 140, which is designated by the letter “D”. Subsequent received data is then sequentially written into said FIFO as it is received, and may contain various information such as data (D) or control information (C).

The receiver for each lane contains a duplicate of the Alignment Detector circuit 101 each with an output corresponding to the detection of a Synch Word signal 110 shown as the collected signals 130 as well as a duplicate of the FIFO memory 102. When the condition of all said detect signals being TRUE has occurred, circuit 105 produces a TRUE output signal 121, which indicates said condition and which is presented to all four FIFO circuits at their respective output logic simultaneously. When Read_En signal 121 is TRUE, then Clock_C 122 is active to read Data 124 in the same order in which it was stored in FIFO 140.

Following this procedure, it is ensured that Data 124 for each of the four lanes is aligned in time such that the skew has been eliminated. Output circuit 103 receives data 150 in parallel from the other three lanes at the correct time because Read_En 121 is distributed to the output port of each FIFO. In some embodiments, circuit 103 receives data 150 from less than the total number of lanes, for example in the event of a failure on one or more lanes. Circuit 103 may also be programmed to read less than the total number of lanes if the total traffic may be supported by fewer lanes, in which case the unused lanes may be shut down in order to conserve electrical power.

After additional processing by circuit 103 the deskewed data is then available to other circuits for subsequent processing or transmission on data link 125 consisting of j physical lines where j is at least 1. It is noted that Clock_C is not required to be the same frequency as Clock_R provided that data can be read from said FIFO at a rate such that said FIFO does not overflow. It will be observed therefore that this invention may perform the function of clock domain adaptation with no additional circuitry. In the event that the FIFO 102 runs out of memory locations prior to being read out, Overflow signal 126 is set to a value of TRUE. Under normal operating conditions the case of Overflow=TRUE will not occur due to the requirement that f(Clock_C)>=f(Clock_R). However, in the event that glitches or other external errors cause FIFO overflow, this signal is available to be used to take corrective action such as causing logic to be reset or raising an alarm.

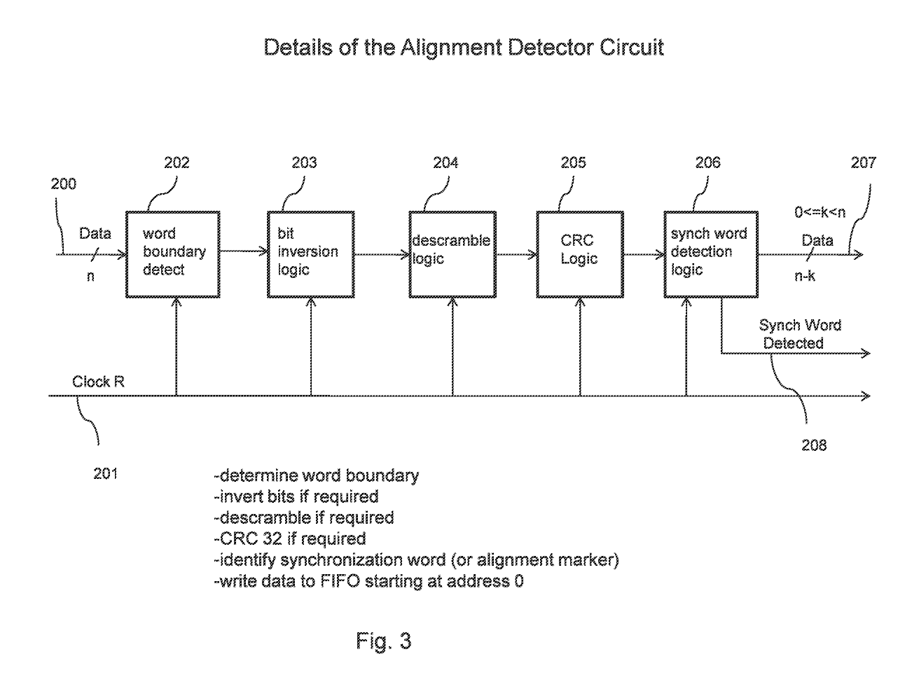

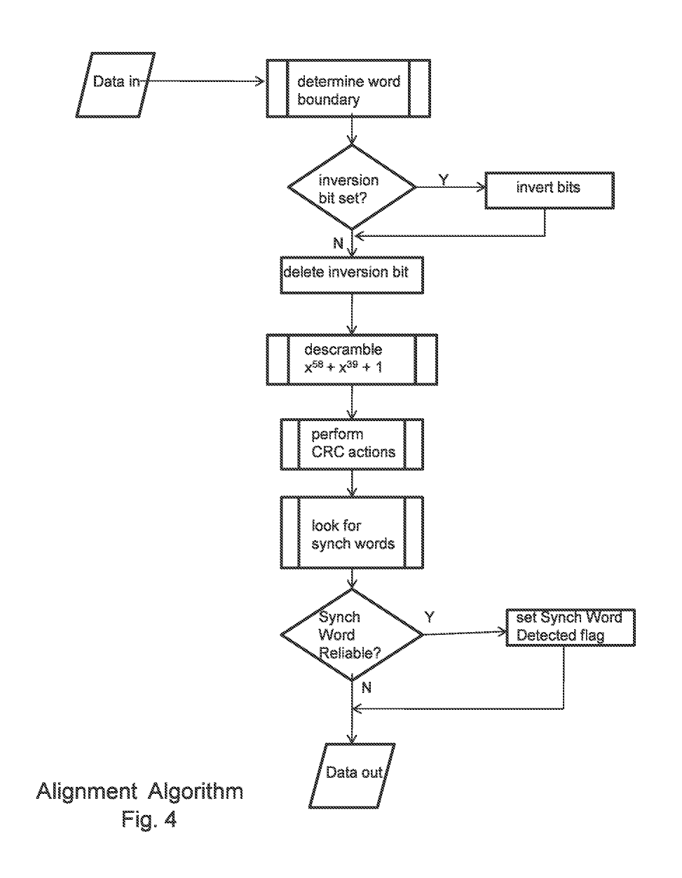

With reference to FIG. 3 and FIG. 4, details of the alignment detector are now described. Recovered Clock_R 201 from the receive SerDes is distributed to the logic functions within the alignment detector. Recovered Data 200 consisting of n parallel signals from the receive SerDes is processed by known word boundary detection logic 202 which determines where each unit of information (word) starts and stops.

In some embodiments, units of information may be smaller or larger depending on the higher layer technologies being implemented. The delineated information units are passed to bit inversion logic 203 which determines whether some bits require negation, this negation having been introduced in order to maintain the dc balance of each lane. The inversion bit is then dropped as it is no longer required.

In some embodiments there is no inversion bit and in other embodiments the inversion bit is not dropped. Data is passed to known descramble logic 204 and output by the same. In other embodiments the descramble logic is not implemented in the alignment detector, for example in the case where the alignment word is not scrambled. Data then passes to known CRC logic 205, which determines if the data is valid, and if so outputs the data to known synch word detection logic 206.

In some embodiments the CRC logic is not implemented in the alignment circuit. Synch word detection logic 206 outputs Data 207 consisting of n-k parallel lines, where k is the number of bits, which are no longer required such as the inversion bit. When a Synch Word is reliably detected, logic 206 also asserts a Synch Word Detected flag 208. The definition of a reliably detected Synch Word is determined by the synch word detection logic 206 and may require the detection of a number of correctly detected Synch Words, for example four in the case of the Interlaken protocol. In some embodiments, the synch word detection logic 206 may be programmed to pass only valid data 207 to its output, with the exclusion of unnecessary filler data such as Skip Words in the case of the Interlaken protocol.

While the example above includes a step whereby the received data bits are periodically inverted in order to maintain dc balance of the electrical signal, this step is not required if the transmitter does not provide periodic inversion, as in the case where this method of obtaining dc balance is not required.

While the example above illustrates communication lanes implemented as electrical signals on conductors or transmission lines, the communication lanes may be sent as optical signals, wireless signals, or on any other medium, which is commonly used for signal transmission with no substantial impact to the skew correction method of the present invention.

While the example above shows two clock domains, Clock R and Clock C, the invention may be implemented using Clock R for both clock domains. Alternatively, Clock R may be sent as a separate signal from the transmitter instead of being embedded in the communication signal on each lane.

In some embodiments the number of transmitted and received lanes will be greater by at least 1 than required by subsequent circuits for the purpose of redundancy and therefore these extra lanes are only used in the event of a failure in one of the normally used lanes. In yet other embodiments the extra lanes are used periodically and in the event of a failed lane there remains sufficient capacity in the remaining lanes to maintain full communication.

Ideally the invention will be implemented in a single integrated circuit (ICs) such as a Field Programmable Gate Array (FPGA) or Application Specific IC (ASIC). However, the invention can be distributed among a number of individual ICs if it is advantageous to do so. It will also be appreciated by persons skilled in the art that the blocks described as “circuits” may be implemented as software modules.

We claim:

1. An apparatus for deskewing serial data streams received on multiple data lanes, wherein each data stream is in the form of a series of blocks comprising a data block preceded by a synchronization block, the apparatus comprising:
an alignment detector for each data stream configured to set a detection flag in response to the valid detection of one or more synchronization blocks in each data stream;
a memory for each data stream for sequentially storing received data following the setting of said detection flag for that data stream;
a read-enable element for setting a read-enable flag in response to the setting of the flag of in respect at least a group of said data streams; and
an output element responsive to said read-enable signal to read data sequentially from each memory under the control of a common output clock.

2. An apparatus as claimed in claim 1, wherein the memory for each data stream comprises a FIFO.

3. An apparatus as claimed in claim 1, wherein the data is written into each said memory under the control of an input clock, which is different from the common output clock.

4. An apparatus as claimed in claim 1, wherein the data is written into each memory under the control of an input clock, which is the same as the common output clock.

5. An apparatus as claimed in claim 1, wherein the read-enable element comprises an AND gate having multiple inputs receiving the detection flags from the respective alignment detectors.

6. An apparatus as claimed in claim 1, wherein the each block is in the form of a series of words, and the synchronization block comprises a synchronization word, and wherein the alignment detector comprises a word boundary detector and logic for detecting the synchronization word in the series of words.

7. An apparatus as claimed in claim 6, wherein the logic for detecting the synchronization word uses the Interlaken specification.

8. An apparatus as claimed in claim 6, wherein the logic for detecting the synchronization word uses the 802.3bs Ethernet specification.

9. An apparatus as claimed in claim 1, wherein the alignment detector further comprises at least one element selected from the group consisting of: bit inversion logic, descramble logic, and CRC logic.

10. An apparatus as claimed in claim 1, wherein at least each memory is implemented by means of a microcontroller under software control.

11. An apparatus as claimed in claim 1, wherein the alignment detector is configured to raise the detection flag only in response to detection of the synchronization block more than once.

12. An apparatus as claimed in claim 1, wherein the read-enable flag is set in response to detection of the synchronization block on all of the data streams.

13. A method of deskewing serial data streams received on multiple data lanes, wherein each data stream is in the form of a series of blocks comprising a data block preceded by a synchronization block, the method comprising:
setting a detection flag in response to the valid detection of one or more synchronization blocks in each data stream; and
writing received data following the setting of said detection flag for that data stream to memory;
reading data sequentially from each memory under the control of a common output clock in response to the setting of the flag in respect at least a group of said data streams.

14. A method as claimed in claim 13, wherein each data stream is written to a FIFO.

15. A method as claimed in claim 13, wherein the data is written into each said memory under the control of an input clock, which is different from the common output clock.

16. A method as claimed in claim 13, wherein the data is written into each memory under the control of an input clock, which is the same as the common output clock.

17. A method as claimed in claim 13, wherein the detection flags from the respective alignment detectors are ANDed together to trigger the reading of the data from each memory.

18. A method as claimed in claim 13, wherein the each block is in the form of a series of words, and the synchronization block comprises a synchronization word, and detection flag is set in response to the detection of the synchronization word in the series of words.

19. A method as claimed in claim 18, wherein the synchronization word is detected using the Interlaken specification.

20. A method as claimed in claim 18, wherein synchronization word is detected using the 802.3b Ethernet specification.

21. A method as claimed in claim 13, wherein which is implemented by means of a microcontroller under software control.

22. A method as claimed in claim 13, wherein the received data is written to memory only after detection of more than one synchronization block.
